(19) United States
(12) Patent Application Publication
(10) Pub. No.: US 2005/0132751 A1
(43) Pub. Date: Jun. 23, 2005

(54) Method for making a precision molding glass and molding device implementing for the method

(75) Inventors: Yuan-Fu Lin, Taichung (TW); Ching-Hua Wang, Taichung (TW)

Correspondence Address: BANNER & WITCOFF, 1001 G STREET N W, SUITE 1100, WASHINGTON, DC, 20001, US

(73) Assignee: ASIA OPTICAL CO., INC., Taichung (TW)

(21) Appl. No.: 10/840,642

(22) Filed: May 7, 2004

(30) Foreign Application Priority Data
Dec. 23, 2003 (TW) 092136547

(51) Int. Cl. C03B 23/00

(52) U.S. Cl. 65/64; 65/105; 65/112; 65/177

(57) ABSTRACT

A method for making a precision molding glass includes the steps of: preparing a molding device including first and second molds, the first mold having a first molding surface, a first edge, and a first distal peripheral portion, the second mold having a second molding surface, a second edge, and a second distal peripheral portion; mounting a centering unit having a shearing portion around the molding device; placing a glass material between the first and second molding surfaces; heating the glass material; molding the glass material until the glass material is pressed to have a predetermined central thickness and until an excess amount of the glass material is squeezed out of the first and second edges; lowering the temperature of the glass material; and while the glass material is still soft, moving the centering unit such that the shearing portion removes the excess amount of the glass material.

### CROSS-REFERENCE TO RELATED APPLICATION

This application claims priority of Taiwanese Application No. 092136547, filed on Dec. 23, 2003.

### BACKGROUND OF THE INVENTION

1. Field of the Invention

The invention relates to a method for making a precision molding glass, and a molding device for implementing the method.

2. Description of the Related Art

In conventional precision glass molding technology, a softened glass material is pressed by two mold portions having opposite molding surfaces to form a solid semi-product. The semi-product is then processed by a centering unit so as to remove an excess amount of the glass material from the semi-product by polishing to obtain a precision molding glass product.

Referring to FIG. 1, the conventional centering unit 1 includes a clamping member 101 for clamping the semi-product 2, and a polishing member 102 for polishing the semi-product 2 to remove the excess amount of the glass material from the semi-product 2. Although the centering unit 1 can be used for removing the excess amount of glass material to make the precision molding glass product, it has the following disadvantages:

1. When the semi-product 2 is clamped by the clamping member 101, a center line of the semi-product 2 is liable to be offset from an axis of the clamping member 101, which in turn results in the introduction of a relatively large error in the precision glass product.

2. The surface of the semi-product is liable to be abraded due to the clamping of the clamping member 101.

3. Since use of the polishing member 102 is required to remove the excess amount of the glass material from the semi-product 2, the cost for making the precision molding glass product is relatively high.

4. Since the precision molding glass product is made by separate molding and centering steps, the conventional method is relatively complicated to practice.

### SUMMARY OF THE INVENTION

Therefore, the object of the present invention is to provide a method for making a precision molding glass having advantages of relatively simple processing, relatively low production costs, and relatively high precision.

In one aspect of this invention, a method for making a precision molding glass includes the steps of:
(a) preparing a molding device including a first mold, and a second mold which has an axis common with that of the first mold, the first mold having a first molding surface centered at the axis, a first peripheral surface extending around the axis and connected to the first molding surface, and a first edge formed between the first molding surface and the first peripheral surface, the first peripheral surface having a first distal peripheral portion distal from the first edge, the second mold having a second molding surface opposite to the first molding surface and centered at the axis, a second peripheral surface extending around the axis and connected to the second molding surface, and a second edge formed between the second molding surface and the second peripheral surface, the second peripheral surface having a second distal peripheral portion distal from the second edge;
(b) mounting a centering unit having a shearing portion around the molding device such that the shearing portion is movable axially between the first and second distal peripheral portions;
(c) placing a glass material between the first and second molding surfaces;
(d) heating the glass material to a molding temperature;
(e) molding the glass material by moving axially the first and second molds toward each other until the glass material is pressed to have a predetermined central thickness and until an excess amount of the glass material is squeezed out of the first and second edges;
(f) lowering the temperature of the glass material; and
(g) while the glass material is still soft, moving the centering unit from one of the first and second distal peripheral portions to the other one of the first and second distal peripheral portions such that the shearing portion of the centering unit removes the excess amount of the glass material.

In another aspect of this invention, a molding device for making a precision molding glass includes a first mold, a second mold having an axis common with that of the first mold, and a centering unit having a shearing portion. The first mold has a first molding surface centered at the axis, a first peripheral surface extending around the axis and connected to the first molding surface, and a first edge formed between the first molding surface and the first peripheral surface. The first peripheral surface has a first distal peripheral portion distal from the first edge. The second mold has a second molding surface opposite to the first molding surface and centered at the axis, a second peripheral surface extending around the axis and connected to the second molding surface, and a second edge formed between the second molding surface and the second peripheral surface. The second peripheral surface has a second distal peripheral portion distal from the second edge. The centering unit is mounted such that the shearing portion is movable axially between the first and second distal peripheral portions.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a centering unit used in a conventional method for making a precision molding glass;

FIG. 2 is a flow diagram of the preferred embodiment of a method for making a precision molding glass according to this invention;

FIGS. 3 to 6 are schematic sectional views showing consecutive steps of the preferred embodiment of FIG. 2; and

FIG. 7 is a sectional view of the precision molding glass made by the preferred embodiment of FIG. 2.

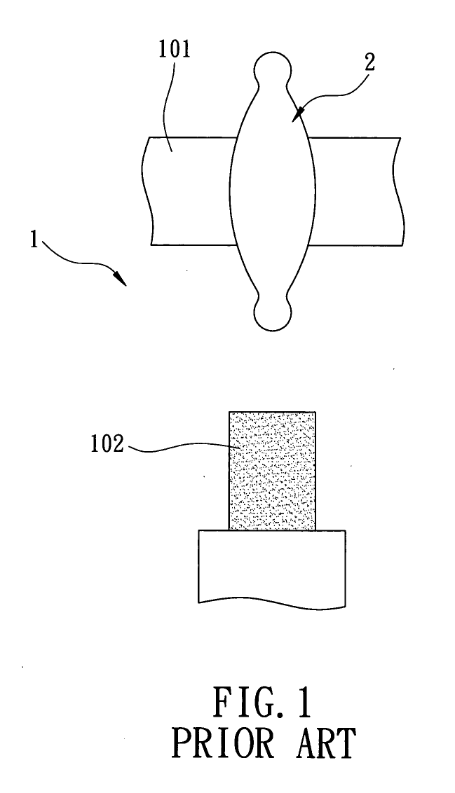

### DETAILED DESCRIPTION OF THE PREFERRED EMBODIMENT

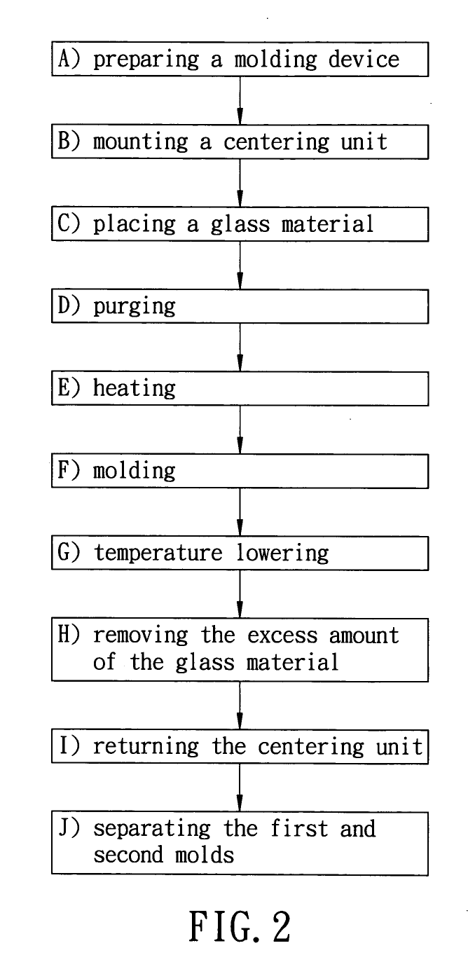

Referring to FIG. 2, the preferred embodiment of the method for making a precision molding glass is shown to include the steps of:

A) Preparing a Molding Device 100:

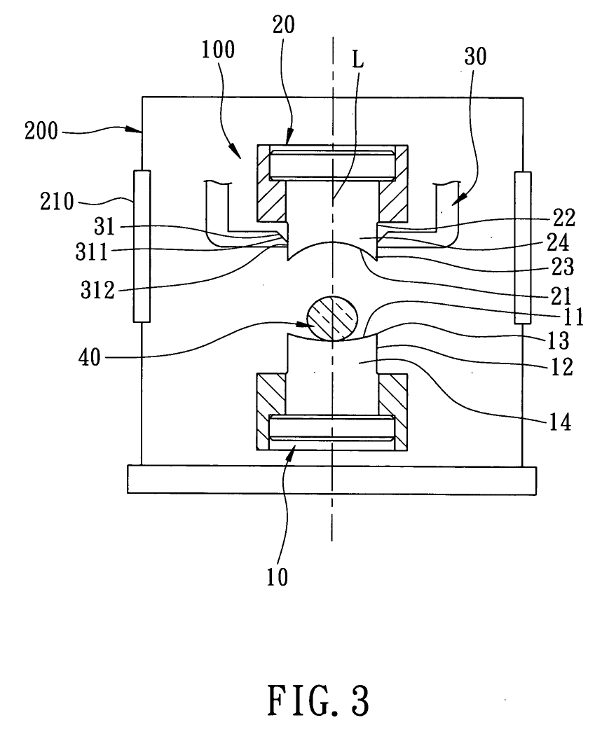

Referring to FIG. 3, the molding device 100 includes a first mold 10, and a second mold 20 which has an axis (L) common with that of the first mold 10. The first mold 10 has a first molding surface 11 centered at the axis (L), a first peripheral surface 12 extending around the axis (L) and connected to the first molding surface 11, and a first edge 13 formed between the first molding surface 11 and the first peripheral surface 12. The first peripheral surface 12 has a first distal peripheral portion 14 distal from the first edge 13. The second mold 20 has a second molding surface 21 opposite to the first molding surface 11 and centered at the axis (L), a second peripheral surface 22 extending around the axis (L) and connected to the second molding surface 21, and a second edge 23 formed between the second molding surface 21 and the second peripheral surface 22. The second peripheral surface 22 has a second distal peripheral portion 24 distal from the second edge 23.

B) Mounting a Centering Unit 30:

The centering unit 30 has a shearing portion 31, and is mounted around the molding device 100 such that the shearing portion 31 is movable axially between the first and second distal peripheral portions 14,24. The shearing portion 31 of the centering unit 30 includes an annular blade 311 extending transversely of the axis (L) of the first and second molds 10,20. The annular blade 311 has a thickness in the direction of the axis (L), and includes a cutting edge 312 proximate to either one of the first and second peripheral surfaces 12, 22. The thickness is gradually enlarged from the cutting edge 312 as the annular blade 311 extends away from the molding device 100.

C) Placing a Glass Material 40:

The glass material 40 is placed between the first and second molding surfaces 11,21.

D) Purging:

In the preferred embodiment, the molding device 100 is mounted within a shield 200, which is made of quartz, and which is provided with a heating element 210. After placing the glass material 40 between the molding surfaces 11,21, the inside of the shield 200 is purged with nitrogen so as to protect the glass material 40 from oxidation.

E) Heating:

The glass material 40 is heated by the heating element 210 to a molding temperature T₁.

F) Molding:

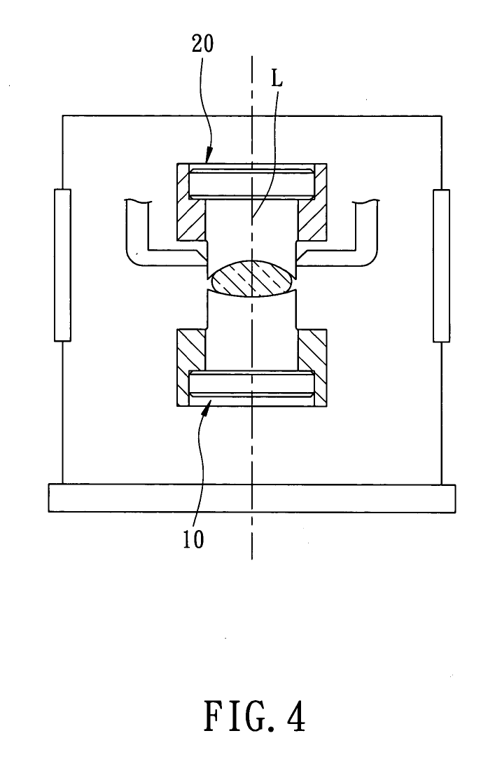

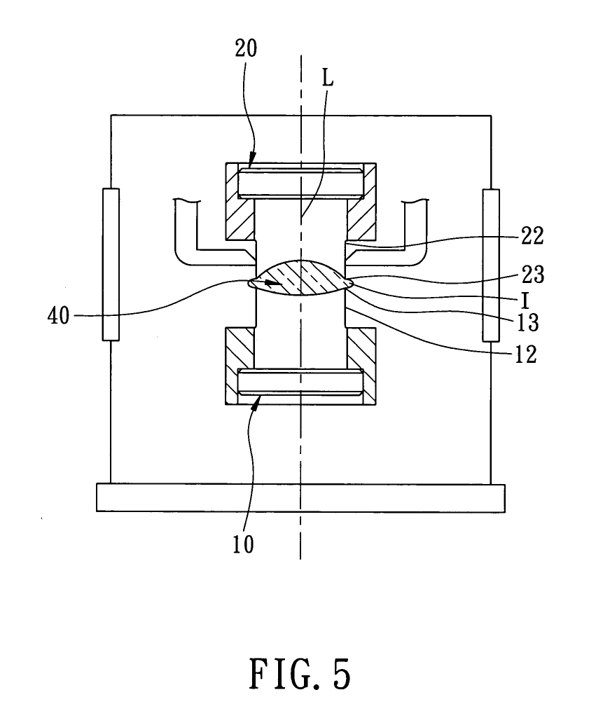

Referring to FIGS. 4 and 5, the glass material 40 is molded by moving axially the first and second molds 10,20 toward each other until the glass material 40 is pressed to have a predetermined central thickness and until an excess amount (I) of the glass material 40 is squeezed out of the first and second edges 13,23.

G) Temperature Lowering:

The temperature of the glass material 40 is lowered to a temperature which is approximate to yield point Aₜ of the glass material 40, and in which the glass material 40 is still in a soft state. H) removing the excess amount (I) of the glass material 40:

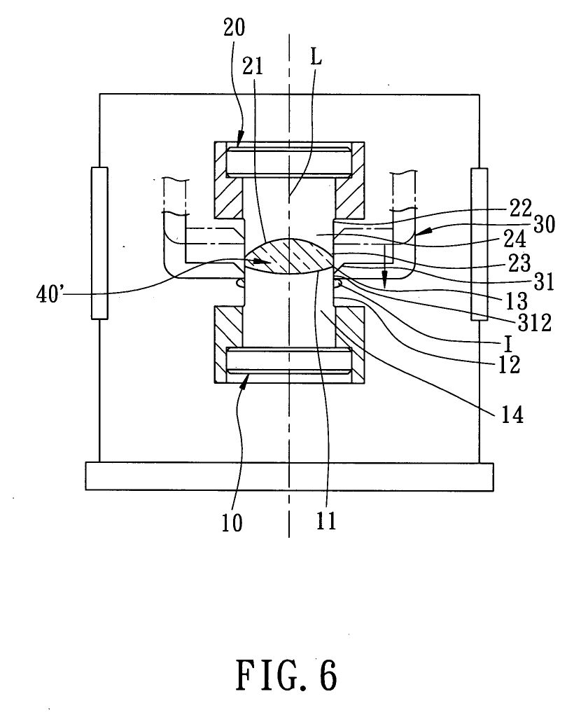

With further reference to FIG. 6, while the glass material 40 is still soft, the centering unit 30 is moved from the second distal peripheral portion 24 to the first distal peripheral portion 14 such that the shearing portion 31 of the centering unit 30 removes the excess amount (I) of the glass material 40 to result in a molded glass 40′. The molding device 100 is maintained in a molding state until the temperature of the molded glass 40′ is lowered below the glass transition temperature T_{g} thereof.

I) Returning the Centering Unit 30:

The centering unit 30 is returned from the first distal peripheral portion 14 back to the second distal peripheral portion 24, as shown by the dotted lines in FIG. 6. Since the annular blade 311 has a thickness that is gradually enlarged from the cutting edge 312 as the annular blade 311 extends away from the molding device 100, the risk of damage to the molded glass 40′ by the annular blade 311 can be reduced.

J) Separating the First and Second Molds 10,20:

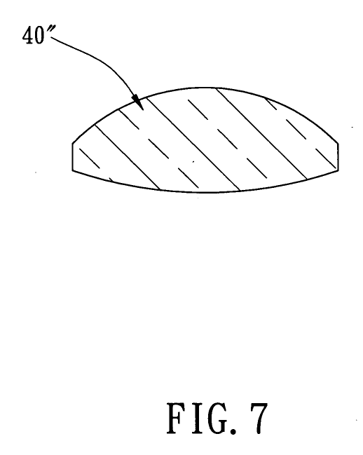

The first and second molds 10,20 are moved away from each other to obtain a precision molding glass 40″, and to permit taking of the precision molding glass 40″ out of the molding device 100. The precision molding glass 40″ thus made is illustrated in FIG. 7.

In view of the aforesaid, since the centering processing is conducted while the molded glass is still in a soft state within the molding device 100, the aforesaid disadvantages of the prior art can be overcome by the molding method of this invention. Furthermore, since the polishing processing is not required in the molding method of this invention, the yield for the precision molding glass 40″ can be increased, and the production cost therefor can be reduced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for making a precision molding glass, comprising the steps of:
(a) preparing a molding device including a first mold, and a second mold which has an axis common with that of said first mold, said first mold having a first molding surface centered at said axis, a first peripheral surface extending around said axis and connected to said first molding surface, and a first edge formed between said first molding surface and said first peripheral surface, said first peripheral surface having a first distal peripheral portion distal from said first edge, said second mold having a second molding surface opposite to said first molding surface and centered at said axis, a second peripheral surface extending around said axis and connected to said second molding surface, and a second edge formed between said second molding surface and said second peripheral surface, said second peripheral surface having a second distal peripheral portion distal from said second edge;
(b) mounting a centering unit having a shearing portion around said molding device such that said shearing portion is movable axially between said first and second distal peripheral portions;
(c) placing a glass material between said first and second molding surfaces;
(d) heating said glass material to a molding temperature;
(e) molding said glass material by moving axially said first and second molds toward each other until said glass material is pressed to have a predetermined central thickness and until an excess amount of said glass material is squeezed out of said first and second edges;
(f) lowering the temperature of said glass material; and
(g) while said glass material is still soft, moving said centering unit from one of said first and second distal peripheral portions to the other one of said first and second distal peripheral portions such that said shearing portion of said centering unit removes said excess amount of said glass material.

2. The method as claimed in claim 1, wherein said shearing portion of said centering unit includes an annular blade extending transversely of said axis of said first and second molds, said annular blade having a thickness in the direction of said axis and including a cutting edge proximate to either one of said first and second peripheral surfaces, said thickness being gradually enlarged from said cutting edge as said annular blade extends away from said molding device.

3. The method as claimed in claim 1, further comprising a step of mounting said molding device within a shield, and purging the inside of said shield with nitrogen after said step (c).

4. The method as claimed in claim 1, further comprising a step of returning said centering unit from said other one of said first and second distal peripheral portions back to said one of said first and second distal peripheral portions after said step (g).

5. The method as claimed in claim 4, further comprising a step of moving said first and second molds away from each other to take said precision molding glass out of said molding device.

6. A molding device for making a precision molding glass, comprising:
a first mold, a second mold which has an axis common with that of said first mold, and a centering unit having a shearing portion,
said first mold having a first molding surface centered at said axis, a first peripheral surface extending around said axis and connected to said first molding surface, and a first edge formed between said first molding surface and said first peripheral surface, said first peripheral surface having a first distal peripheral portion distal from said first edge,
said second mold having a second molding surface opposite to said first molding surface and centered at said axis, a second peripheral surface extending around said axis and connected to said second molding surface, and a second edge formed between said second molding surface and said second peripheral surface, said second peripheral surface having a second distal peripheral portion distal from said second edge,
said centering unit being mounted such that said shearing portion is movable axially between said first and second distal peripheral portions.

7. The molding device as claimed in claim 6, wherein said shearing portion of said centering unit includes an annular blade extending transversely of said axis of said first and second molds, said annular blade having a thickness in the direction of said axis and including a cutting edge proximate to either one of said first and second peripheral surfaces, said thickness being gradually enlarged from said cutting edge as said annular blade extends away from said molding device.
